(19) United States
(12) Patent Application Publication
(10) Pub. No.: US 2023/0085195 A1
(43) Pub. Date: Mar. 16, 2023

(54) ENHANCED LEARNING CONTENT IN AN INTERCONNECTED ENVIRONMENT

(71) Applicant: International Business Machines Corporation, Armonk, NY (US)

(72) Inventors: Venkata Vara Prasad Karri, Visakhapatnam (IN); Sarbajit K. Rakshit, Kolkata (IN); Shailendra Moyal, Pune (IN); Madhukar Hari Kishan Gobbi, Visakhapatnam (IN); Akash U. Dhoot, Pune (IN)

(21) Appl. No.: 17/474,268

(22) Filed: Sep. 14, 2021

(51) Int. Cl. G06N 20/00; G06T 19/00; G06F 16/9535; G06F 16/9536; G06F 40/30

(52) U.S. Cl. CPC G06N 20/00; G06T 19/006; G06F 16/9535; G06F 16/9536; G06F 40/30

(57) ABSTRACT

A tool for providing enhanced learning content in an interconnected smart environment. The tool determines one or more objects and associated object capabilities for each of the one or more objects in the interconnected smart environment. The tool determines one or more user activities and associated user data. The tool determines one or more subject matter scores based, at least in part, on the one or more user activities and the associated user data. The tool determines a level of engagement for a topic based, at least in part, on the one or more subject matter scores and the associated object capabilities for each of the one or more objects in the interconnected smart environment. Responsive to detecting the user performing the activity related to the topic, the tool provides enhanced learning content to the user utilizing a smart device and one or more objects in the interconnected smart environment.

### BACKGROUND OF THE INVENTION

The present invention relates generally to computing device functionality, and more particularly to enhanced learning content in an interconnected smart environment.

A smart environment links computers and other smart devices to everyday settings and tasks. Smart environments include smart homes, smart cities, smart workplaces and smart manufacturing. Smart environments include sensors and computers that are integrated with everyday objects that are interconnected over a network. Smart environments are broadly characterized as having features including remote control of devices, such as power line communication systems control devices, wireless communication to form a collection of devices and environments, information acquisition and dissemination from sensor networks, enhanced services by intelligent smart devices, and predictive and decision-making skills.

### SUMMARY

Aspects of an embodiment of the present invention disclose a method, computer program product, and computer system for providing enhanced learning content in an interconnected smart environment. The method includes determining, by one or more computer processors, one or more objects and associated object capabilities for each of the one or more objects in the interconnected smart environment. The method further includes determining, by the one or more computer processors, one or more user activities and associated user data. The method further includes determining, by the one or more computer processors, one or more subject matter scores based, at least in part, on the one or more user activities and the associated user data. The method further includes determining, by the one or more computer processors, a level of engagement for a topic based, at least in part, on the one or more subject matter scores and the associated object capabilities for each of the one or more objects in the interconnected smart environment, wherein the level of engagement indicates a volume and a scope of enhanced learning content to be provided to a user. The method further includes detecting, by the one or more computer processors, the user performing an activity related to the topic. Responsive to detecting the user performing the activity related to the topic, the method further includes providing, by the one or more computer processors, based, at least in part, on the level of engagement, the enhanced learning content to the user utilizing a smart device and the one or more objects in the interconnected smart environment.

### BRIEF DESCRIPTION OF THE DRAWINGS

FIG. 1 illustrates a data processing environment, generally designated 100, in accordance with an embodiment of the present invention.

FIG. 2 is a flowchart depicting operational steps of an enhanced learning program, such as the enhanced learning program of FIG. 1, generally designated 200, for providing enhanced learning content in an interconnected smart environment, in accordance with an embodiment of the present invention.

FIG. 3 is a block diagram depicting components of a data processing environment, such as the server of FIG. 1, generally designated 300, in accordance with an embodiment of the present invention.

### DETAILED DESCRIPTION

Embodiments of the present invention recognize that in a computerized learning environment, where more individuals are engaging in education virtually through available online platforms, it can prove difficult to understand concepts and topics only watching videos and listening to lectures. Embodiments of the present invention recognize that some individuals learn better with hands on experiences.

Embodiments of the present invention provide enhanced learning content in an interconnected smart environment. Embodiments of the present invention further provide the capability to utilize connected physical objects and smart devices available in proximity to a user in a smart environment to deliver more robust learning experiences in real time while performing activities in a gamification scenario. Embodiments of the present invention provide an improvement to smart environment and smart device capability as it relates to interactions with a user. Embodiments of the present invention provide the capability for smart devices to engage with a user in various smart environments in an educational capacity to deliver an enhanced learning experience utilizing surrounding physical objects and augmented reality (AR) technology.

Implementation of such embodiments may take a variety of forms, and exemplary implementation details are discussed subsequently with reference to the Figures.

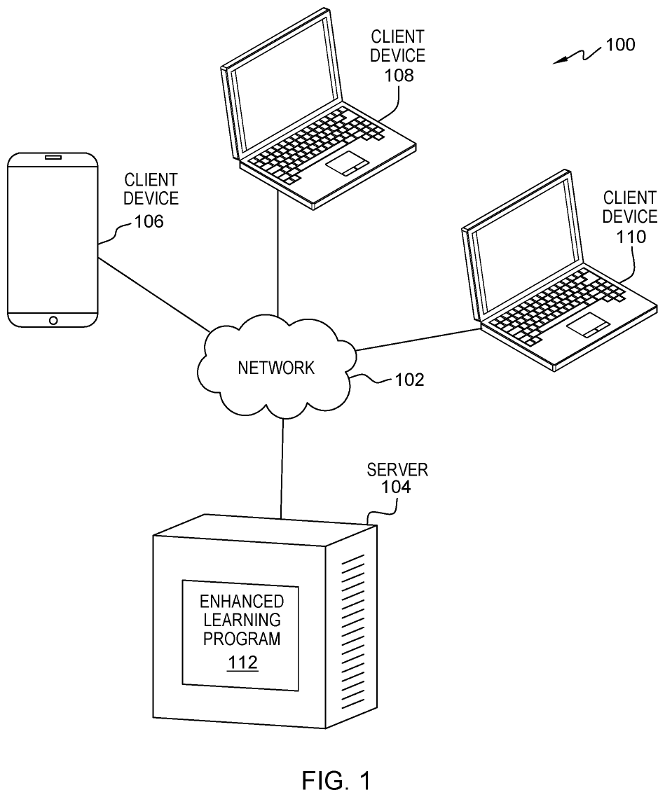

Referring now to various embodiments of the invention in more detail, FIG. 1 is a functional block diagram that illustrates a data processing environment, generally designated 100, suitable for providing enhanced learning content in an interconnected smart environment, in accordance with at least one embodiment of the invention. The present invention will now be described in detail with reference to the Figures. FIG. 1 provides only an illustration of one implementation and does not imply any limitations with regard to the environments in which different embodiments may be implemented. Many modifications to the depicted environment may be made by those skilled in the art without departing from the scope of the invention as recited by the claims. FIG. 1 includes network 102, server 104, which includes enhanced learning program 112, and one or more client devices, such as client device 106, client device 108, and client device 110.

In one embodiment, network 102 is the Internet representing a worldwide collection of networks and gateways that use TCP/IP protocols to communicate with one another. Network 102 may include wire cables, wireless communication links, fiber optic cables, routers, switches and/or firewalls. Server 104, client device 106, client device 108, and client device 110 are interconnected by network 102. Network 102 can be any combination of connections and protocols capable of supporting communications between server 104, client device 106, client device 108, client device 110, and enhanced learning program 112. Network 102 can be, for example, a telecommunications network, a local area network (LAN), a virtual local area network (VLAN), a wide area network (WAN), such as the Internet, or a combination of the three, and can include wired, wireless, or fiber optic connections. Network 102 may include one or more wired and/or wireless networks that are capable of receiving and transmitting data, voice, and/or video signals, including multimedia signals that include voice, data, and video information. In general, network 102 may be any combination of connections and protocols that will support communications between server 104, client device 106, client device 108, client device 110, and enhanced learning program 112, as well as other computing devices (not shown) within data processing environment 100. FIG. 1 is intended as an example and not as an architectural limitation for the different embodiments.

In one embodiment, server 104 may be, for example, a server computer system such as a management server, a web server, or any other electronic device or computing system capable of sending and receiving data. In another embodiment, server 104 may be a data center, consisting of a collection of networks and servers, such as virtual servers and applications deployed on virtual servers, to an external party. In another embodiment, server 104 represents a “cloud” of computers interconnected by one or more networks, where server 104 is a computing system utilizing clustered computers and components to act as a single pool of seamless resources when accessed through network 102. This is a common implementation for data centers in addition to cloud computing applications. In one embodiment, server 104 includes enhanced learning program 112 for providing enhanced learning content in an interconnected smart environment utilizing one or more smart devices, illustrated by client device 106, client device 108, and client device 110, respectively.

In one embodiment, enhanced learning program 112 operates on a central server, such as server 104, and can be utilized by one or more client devices, such as client device 106, client device 108, and client device 110, via an application download from the central server or a third-party application store and executed on the one or more client devices. In another embodiment, enhanced learning program 112 may be software, downloaded from a central server, such as server 104, and installed on one or more client devices, such as client device 106, client device 108, and client device 110. In yet another embodiment, enhanced learning program 112 may be utilized as a software service provided by a third-party cloud service provider (not shown). In yet another embodiment, enhanced learning program 112 may include one or more fully integrated components (not shown), such as add-ons, plug-ins, and agent programs, etc., or one or more components installed on one or more client devices, such as client device 106, client device 108, and client device 110, to provide enhanced learning content in an interconnected smart environment. In one embodiment, enhanced learning program 112 can be an add-on feature to a computer program (e.g., learning program, professional education tool, product education program, web browser, social media application, training program, etc.) that provides a user with enhanced learning content via one or more interconnected smart devices while performing an activity with one or more physical objects. In one embodiment, enhanced learning program 112 can be fully integrated, partially integrated, or separate from a third-party service (e.g., collaboration service, communication service, etc.). In one embodiment, enhanced learning program 112 may be an application, downloaded from an application store or third-party provider, capable of being used in conjunction with a computer program during interactions between one or more authorized users utilizing a plurality of user devices, such as client device 106, client device 108, and client device 110, to provide enhanced learning content in an interconnected smart environment.

In one embodiment, enhanced learning program 112 can be utilized by one or more user devices, such as client device 106, client device 108, and client device 110, to provide enhanced learning content in an interconnected smart environment. In one embodiment, enhanced learning program 112 delivers enhanced learning content to a user via one or more interconnected smart devices while the user is performing an activity with one or more physical objects. In one embodiment, enhanced learning program 112 provides the capability to identify object capabilities of various physical objects and device capabilities of one or more interconnected smart devices in an environment and create a technical concepts workflow mapping for each of physical objects and the one or more interconnected smart devices readily available. In one embodiment, enhanced learning program 112 creates a mapping of learning concepts for a user based on one or more activities and professional learning data associated with the user. In one embodiment, enhanced learning program 112 generates mappings of learning concepts with technical concepts workflows with one or more smart devices and one or more objects available (i.e., active and in proximity to a user) in an environment. In one embodiment, enhanced learning program 112 identifies one or more smart devices to be involved in performing one or more activities, selects at least one of the one or more devices, and leverages various device capabilities of the one or more smart devices to perform various activities and provide an enhanced learning experience. In one embodiment, enhanced learning program 112 creates a gamification environment to perform one or more derived activities using one or more smart devices and provides integration with an AR environment or a VR environment, such that a user can perform the one or more derived activities utilizing a client device capable of supporting AR and VR. In one embodiment, enhanced learning program 112 tracks one or more objects and one or more smart devices used in various activities performed by a user and creates an associated knowledge corpus for determining when to involve a smart device in an activity to provide enhanced learning content, and what smart device is best suited for involvement in the various activities. In one embodiment, enhanced learning program 112 may utilize an integrated artificial intelligence (AI) voice assistance-based system to guide a user on how one or more devices can be involved to perform various activities and provide enhanced learning content during the various activities. In one embodiment, enhanced learning program 112 performs analysis on one or more activities performed by a user and generates an assessment score to be utilized to prioritize one or more smart devices for the one or more activities based, at least in part, on a level of involvement (i.e., smart device providing enhanced learning content) needed to facilitate a more robust learning experience.

In one embodiment, enhanced learning program 112 creates a user profile that can be shared and linked with other user profiles, for example within a home, a workplace, and a school, etc., to encourage interactive learning with the other users for similar professional learning and higher studies. In one embodiment, enhanced learning program 112 generates a gamified learning experience by creating a virtual platform audio and video communication initiated by a user device, and by utilizing various user profiles to activate communication to connect a plurality of users with various learning activities. In one embodiment, enhanced learning program 112 captures feedback of a user to improve association of learning concepts and user activities designed to explain the concepts more robustly. In one embodiment, enhanced learning program 112 provides the capability to create motivation while engaging in professional and personal learning by assigning rewards and points integrated with learning milestones (e.g., hours tracking, recognition, content completed, etc.) and rewards tool. In one embodiment, enhanced learning program 112 identifies a learning need of a user based, at least in part, on demonstrated skills, types of user activities, etc., and creates a gamification experience for the user while learning where the user can earn rewards and points. In one embodiment, enhanced learning program 112 detects various user activities (e.g., physical activity, virtual/digital activity, etc.), evaluates a user competency level for concepts associated with the various user activities and based, at least in part on the various user activities and the user competency level for concepts associated with the various user activities, creates an enhanced learning experience to teach concepts and topics related to the various user activities. For example, where enhanced learning program 112 detects that a user is opening a refrigerator door, enhanced learning program 112 may create an enhanced learning experience utilizing a VR headset and gamification scenarios to teach the user about cooling circuits within the refrigerator.

In one embodiment, enhanced learning program 112 may be configured to access various data sources, such as a database or repository (not shown), that may include personal data, content, contextual data, or information that a user does not want to be processed. Personal data includes personally identifying information or sensitive personal information as well as user information, such as location tracking or geolocation information. Processing refers to any operation, automated or unautomated, or set of operations such as collecting, recording, organizing, structuring, storing, adapting, altering, retrieving, consulting, using, disclosing by transmission, dissemination, or otherwise making available, combining, restricting, erasing, or destroying personal data. In one embodiment, enhanced learning program 112 enables the authorized and secure processing of personal data. In one embodiment, enhanced learning program 112 provides informed consent, with notice of the collection of personal data, allowing the user to opt in or opt out of processing personal data. Consent can take several forms. Opt-in consent can impose on the user to take an affirmative action before personal data is processed. Alternatively, opt-out consent can impose on the user to take an affirmative action to prevent the processing of personal data before personal data is processed. In one embodiment, enhanced learning program 112 provides information regarding personal data and the nature (e.g., type, scope, purpose, duration, etc.) of the processing. In one embodiment, enhanced learning program 112 provides a user with copies of stored personal data. In one embodiment, enhanced learning program 112 allows the correction or completion of incorrect or incomplete personal data. In one embodiment, enhanced learning program 112 allows the immediate deletion of personal data.

In one embodiment, client device 106, client device 108, and client device 110 are clients to server 104 and may be, for example, a desktop computer, a laptop computer, a tablet computer, a personal digital assistant (PDA), a smart phone, a thin client, or any other electronic device or computing system capable of communicating with server 104 through network 102. For example, client device 106 may be a mobile device, such as a smart phone, capable of connecting to a network, such as network 102, to access the Internet, utilize an enhanced learning program, one or more software applications, and one or more input/output devices (e.g., camera, microphone, speakers, sensors, etc.). In one embodiment, client device 106, client device 108 and client device 110 may be a smart device interconnected over a network in a smart environment. For example, client device 106, client device 108 and client device 110 may be a collection of smart devices commonly found in various smart environments, including, but not limited to, smart home environments, smart work environments, and smart retail spaces, etc. In one embodiment, client device 106, client device 108, and client device 110 may be any suitable type of Internet of Things (IoT) device capable of executing one or more applications or programs utilizing an IoT structure, a mobile operating system or a computer operating system, capturing data from one or more sources or sensors, and sending the data to a server or program for processing. In one embodiment, client device 106, client device 108, and client device 110 may be any suitable type of client device capable of executing one or more applications utilizing a mobile operating system or a computer operating system. In one embodiment, client device 106, client device 108, and client device 110 may include a user interface (not shown) for providing a user with the capability to interact with enhanced learning program 112, and one or more authorized users via a computer device, such as client device 108 and client device 110. A user interface refers to the information (such as graphic, text, and sound) a program presents to a user and the control sequences the user employs to control the program. There are many types of user interfaces. In one embodiment, the user interface may be a graphical user interface (GUI). A GUI is a type of user interface that allows users to interact with electronic devices, such as a keyboard and mouse, through graphical icons and visual indicators, such as secondary notations, as opposed to text-based interfaces, typed command labels, or text navigation. In computers, GUIs were introduced in reaction to the perceived steep learning curve of command-line interfaces, which required commands to be typed on the keyboard. The actions in GUIs are often performed through direct manipulation of the graphics elements.

In one embodiment, client device 106, client device 108, and client device 110 may be any wearable electronic devices, including wearable electronic devices affixed to eyeglasses and sunglasses, helmets, wristwatches, clothing, wigs, tattoos, embedded devices, and the like, capable of sending, receiving, and processing data. In one embodiment, client device 106, client device 108, and client device 110 may be any wearable computer capable of supporting enhanced learning in an interconnected smart environment. For example, client device 106, client device 108, and client device 110 may be smart devices capable of supporting augmented reality (AR) and virtual reality (VR) experiences while delivering enhanced learning content to a user in an interconnected smart environment. In one embodiment, client device 106, client device 108, and client device 110 may include one or more sensors (e.g., heart rate monitors, blood oxygen saturation sensors, sleep sensors, accelerometers, motion sensors, thermal sensors, radio frequency identification (RFID) sensors, cameras, microphones, etc.) for gathering contextual data during user performance of one or more activities, and providing a solution for providing enhanced learning content in an interconnected smart environment. Wearable computers are miniature electronic devices that may be worn by the bearer under, with, or on top of clothing, as well as in or connected to glasses, hats, or other accessories. Wearable computers are especially useful for applications that require more complex computational support than merely hardware coded logics. In general, client device 106, client device 108, and client device 110 each represent one or more programmable electronic devices or combination of programmable electronic devices capable of executing machine readable program instructions and communicating with other computing devices (not shown) within data processing environment 100 via a network, such as network 102.

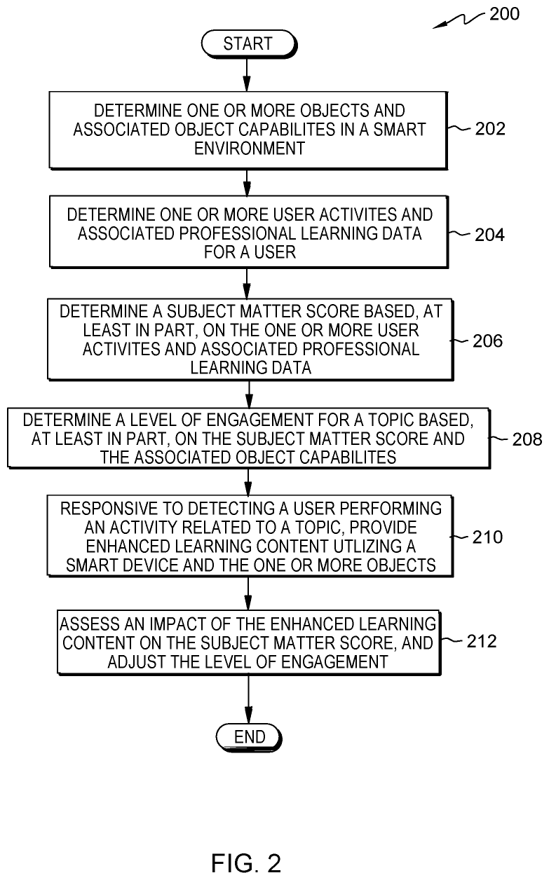

FIG. 2 is a flowchart depicting operational steps of an enhanced learning program, such as enhanced learning program 112, generally designated 200, for providing enhanced learning content across one or more computer devices in an interconnected smart environment, in accordance with an embodiment of the present invention. Although FIG. 2 depicts operational steps of an enhanced learning program for providing enhanced learning content across one or more computer devices in an interconnected smart environment, embodiments of the present invention may be similarly practiced by a physical home assistant device for providing enhanced learning content across one or more computer devices in an interconnected smart environment.

Enhanced learning program 112 determines one or more objects and associated object capabilities in a smart environment (202). In one embodiment, enhanced learning program 112 determines one or more objects and associated object capabilities for each of the one or more objects in a smart environment. In one embodiment, enhanced learning program 112 utilizes (e.g., accessing, instructing, querying, etc.) one or more interconnected smart devices in the smart environment to identify the one or more objects and associated object capabilities. For example, enhanced learning program 112 may utilize an artificial intelligence (AI) home assistant device that is interconnected wirelessly with one or more smart devices, such as a smart phone, a laptop computer, a smart television, a smart refrigerator, a security camera system, etc., to identify one or more physical objects and associated object capabilities for each of the one or more physical objects in the smart environment. In one embodiment, enhanced learning program 112 may utilize machine learning and AI techniques to query a knowledge base, the Internet, or any other relevant sources, to derive the associated object capabilities for each of the one or more physical objects. For example, enhanced learning program 112 may identify a smart refrigerator interconnected with a home assistant device, and gather model information, technical drawings, and general refrigerator capabilities and product information from various internet sources to derive associated object capabilities of the smart refrigerator. In one embodiment, enhanced learning program 112 determines, based, at least in part, on derived associated object capabilities for the one or more objects, each of the one or more objects that can be utilized for providing professional learning, concepts, and topics relative to various user activities. For example, where a user is a mechanical engineer by profession, enhanced learning program 112 may determine that, based, at least in part, on the associated object capabilities of a smart washing machine in a smart environment, the smart washing machine can be utilized to provide deep insight into how a mechanical washing machine transmission works to spin and agitate laundry while the user is doing a load of laundry.

Enhanced learning program 112 determines one or more user activities and associated professional learning data for a user (204). In one embodiment, enhanced learning program 112 determines one or more user activities and associated professional learning data for a user (i.e., user data) by capturing (i.e., gathering) various user data including, but not limited to, professional details (e.g., occupation, education, licenses, etc.), area of interest for learning (e.g., work related areas of interest, professional areas of interest, hobbies, recreation, etc.), day to day activities performed by the user (e.g., occupation requirements, personal activities, etc.) and a user activity schedule (e.g., time of day and frequency of activities performed by the user), etc. In one embodiment, enhanced learning program 112 may be integrated with various other collaboration tools and learning and knowledge center platforms, etc. to further capture associated user data from various social media channels or digital medium that the user leverages for professional and recreational learning. In one embodiment, enhanced learning program 112 may record a point in time for various learning sessions that the user participates in, such as in class learning, job related training, continued learning education events and direct communications with a subject matter expert. In one embodiment, enhanced learning program 112 classifies the one or more user activities and the associated professional learning data. In one embodiment, enhanced learning program 112 classifies the one or more user activities and the associated user data by subject matter, by user interest related to a topic, and by a level of understanding of the topic.

Enhanced learning program 112 determines a subject matter score based, at least in part, on the one or more user activities and the associated professional learning data (206). In one embodiment, enhanced learning program 112 determines a subject matter score based, at least in part, on the one or more user activities and the associated professional learning data by classifying the one or more user activities and the associated professional learning data. In one embodiment, enhanced learning program 112 classifies the one or more user activities and the associated professional learning data into one or more categories including, but not limited to, subject matter, user interest related to a topic and a level of understanding of the topic. In one embodiment, enhanced learning program 112 calculates a plurality weighted values for each of the one or more categories to assign one or more subject matter scores, where the one or more subject matter scores indicate a level of understanding (e.g., knowledge base) for a user relative to one or more specific topics and one or more subject matter areas.

Enhanced learning program 112 determines a level of engagement for a topic based, at least in part, on the subject matter score and the associated object capabilities (208). In one embodiment, enhanced learning program 112 determines a level of engagement for a topic based, at least in part, on the subject matter score and the associated object capabilities by comparing subject matter scores for a user to relevant associated object capabilities for the one or more objects available in the smart environment, and based on the comparison, determine a level of engagement for one or more topics, where the level of engagement is an indication of a level of involvement from one or more smart devices, the one or more objects, and a volume of enhanced learning content provided by the one or more smart devices that aligns with an educational requirement of a user, the one or more subject matter scores and the relevant associated object capabilities available. In one embodiment, enhanced learning program 112 may tag one or more topics or subject matter areas to indicate a level of user proficiency in the one or more topics or subject matter areas (e.g., sufficient, excels, needs improvement, etc.). In one embodiment, a low subject matter score may dictate a higher level of engagement, whereas a higher subject matter score may dictate a lower level of engagement. In one embodiment, enhanced learning program 112 analyzes relevant associated object capabilities (i.e., relevant object functions) for the one or more objects available in the smart environment and day-to-day activities of the user that can be leveraged to determine enhanced learning content that satisfies the level of engagement for a specific topic.

Responsive to detecting a user performing an activity related to a topic, enhanced learning program 112 provides enhanced learning content utilizing a smart device and the one or more objects (210). In one embodiment, enhanced learning program 112 detects a user performing an activity related to a topic by leveraging AI and machine learning techniques to identify when a user interacts with one or more objects and/or one or more smart devices in a smart environment.

In one embodiment, artificial intelligence (AI) techniques may include machine learning, where machines are not explicitly programmed to perform certain tasks. Rather, they learn and improve from experience automatically. Deep Learning is a subset of machine learning based on artificial neural networks for predictive analysis. There are various machine learning algorithms, such as Unsupervised Learning, Supervised Learning, and Reinforcement Learning. In Unsupervised Learning, the algorithm does not use classified information to act on it without any guidance. In Supervised Learning, it deduces a function from the training data, which consists of a set of an input object and the desired output. Reinforcement learning is used by machines to take suitable actions to increase the reward to find the best possibility which should be considered. In some embodiments, machine Learning is a reliable technology for Natural Language Processing (NLP) to obtain meaning from human languages. In NLP, the audio of a human talk is captured by the machine. Then the audio to text conversation occurs, and then the text is processed where the data is converted into audio. Then the machine uses the audio to respond to humans. Applications of NLP can be found in IVR (Interactive Voice Response) applications used in call centers, language translation applications and word processors to check the accuracy of grammar in text. However, the nature of human languages makes the Natural Language Processing difficult because of the rules which are involved in the passing of information using natural language, and they are not easy for the computers to understand. NLP uses algorithms to recognize and abstract the rules of the natural languages where the unstructured data from the human languages can be converted to a format that is understood by the computer. In other embodiments, AI techniques can capture visual information and then analyze it. Here cameras are used to capture the visual information, the analogue to digital conversion is used to convert the image to digital data, and digital signal processing is employed to process the data. Then the resulting data is fed to a computer. In machine vision, two vital aspects are sensitivity, which is the ability of the machine to perceive impulses that are weak and resolution, the range to which the machine can distinguish the objects. The usage of machine vision can be found in signature identification, pattern recognition, and medical image analysis, etc.

Responsive to detecting the user performing an activity related to one or more topics, enhanced learning program 112 determines a volume of enhanced learning content that aligns with the subject matter score and the level of engagement for the one or more topics. In one embodiment, enhanced learning program 112 may apply gamification techniques to create insightful enhanced learning content related to the one or more topics (e.g., tagged topics) or subject matter areas (e.g., tagged subject matter areas) that aligns with the subject matter score and the level of engagement for the one or more topics. In one embodiment, enhanced learning program 112 gathers enhanced learning content related to the one or more topics and the subject matter areas and delivers the enhanced learning content to the user via a smart device utilizing audio and visual notification techniques. In one embodiment, enhanced learning program 112 may function as an echo system where the smart environment is further integrated with AR/VR environment available to a user, as well as various web crawler platforms, to deliver more enhanced learning content where the level of engagement cannot be completely fulfilled by the relevant one or more objects available within smart environment. In one embodiment, enhanced learning program 112 may fetch relevant enhanced learning content from crowd sourced systems and create visualizations to be delivered to an AR/VR system available to the user to continue providing enhanced learning content feeds while user is performing one or more activities related to one or more topics.

Enhanced learning program 112 assesses an impact of the enhanced learning content on the subject matter score and adjust the level of engagement (212). In one embodiment, enhanced learning program 112 assesses an improvement to the subject matter score by deriving the subject matter score after delivering the enhanced learning content. In one embodiment, enhanced learning program 112 analyzes the assessment (e.g., a change in the subject matter score) to determine relevant modifications to the gamification techniques, the relevant one or more objects available in the smart environment, and crowd sourced data sources used to deliver enhanced learning content. In one embodiment, based, at least in part, on the analysis, enhanced learning program 112 adjusts the level of engagement to more effectively impact the subject matter score to meet the educational expectations of the user. In one embodiment, enhanced learning program 112 may update various gamification scenarios associated with enhanced learning content for the one or more topics and subject matter areas, and publish (i.e., share) for additional users to reference in a crowd sourced learning environment.

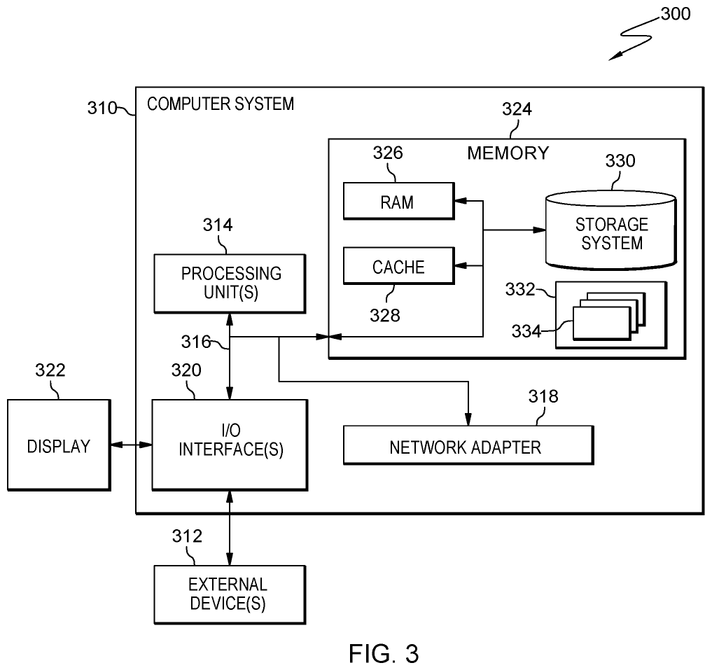

FIG. 3 is a block diagram depicting components of a data processing environment, such as server 104 of data processing environment 100, generally designated 300, in accordance with an embodiment of the present invention. It should be appreciated that FIG. 3 provides only an illustration of one implementation and does not imply any limitations with regard to the environments in that different embodiments may be implemented. Many modifications to the depicted environment may be made.

In the illustrative embodiment, server 104 in data processing environment 100 is shown in the form of a general-purpose computing device, such as computer system 310. The components of computer system 310 may include, but are not limited to, one or more processors or processing unit(s) 314, memory 324 and bus 316 that couples various system components including memory 324 to processing unit(s) 314.

Bus 316 represents one or more of any of several types of bus structures, including a memory bus or memory controller, a peripheral bus, an accelerated graphics port and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus and Peripheral Component Interconnect (PCI) bus.

Computer system 310 typically includes a variety of computer system readable media. Such media may be any available media that is accessible by computer system 310 and it includes both volatile and non-volatile media, removable and non-removable media.

Memory 324 can include computer system readable media in the form of volatile memory, such as random access memory (RAM) 326 and/or cache memory 328. Computer system 310 may further include other removable/non-removable, volatile/non-volatile computer system storage media. By way of example only, storage system 330 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”) and an optical disk drive for reading from or writing to a removable, non-volatile optical disk, such as a CD-ROM, DVD-ROM or other optical media can be provided. In such instances, each can be connected to bus 316 by one or more data media interfaces. As will be further depicted and described below, memory 324 may include at least one computer program product having a set (e.g., at least one) of program modules that are configured to carry out the functions of embodiments of the invention.

Program/utility 332, having one or more sets of program modules 334, may be stored in memory 324 by way of example and not limitation, as well as an operating system, one or more application programs, other program modules and program data. Each of the operating systems, one or more application programs, other program modules and program data or some combination thereof, may include an implementation of a networking environment. Program modules 334 generally carry out the functions and/or methodologies of embodiments of the invention as described herein. Computer system 310 may also communicate with one or more external device(s) 312, such as a keyboard, a pointing device, a display 322, etc. or one or more devices that enable a user to interact with computer system 310 and any devices (e.g., network card, modem, etc.) that enable computer system 310 to communicate with one or more other computing devices. Such communication can occur via Input/Output (I/O) interface(s) 320. Still yet, computer system 310 can communicate with one or more networks, such as a local area network (LAN), a general wide area network (WAN) and/or a public network (e.g., the Internet) via network adapter 318. As depicted, network adapter 318 communicates with the other components of computer system 310 via bus 316. It should be understood that although not shown, other hardware and software components, such as microcode, device drivers, redundant processing units, external disk drive arrays, RAID systems, tape drives and data archival storage systems may be used in conjunction with computer system 310.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable) or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems) and computer program products according to embodiments of the invention. It will be understood that each block of the flowchart illustrations and/or block diagrams and combinations of blocks in the flowchart illustrations and/or block diagrams, can be implemented by computer readable program instructions.

These computer readable program instructions may be provided to a processor of a general purpose computer, a special purpose computer or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus or other device to cause a series of operational steps to be performed on the computer, other programmable apparatus or other device to produce a computer implemented process, such that the instructions which execute on the computer, other programmable apparatus or other device implement the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace or to enable others of ordinary skill in the art to understand the embodiments disclosed herein.

The terminology used herein is for the purpose of describing particular embodiments only and is not intended to be limiting of the invention. It should be appreciated that any particular nomenclature herein is used merely for convenience and thus, the invention should not be limited to use solely in any specific function identified and/or implied by such nomenclature. Furthermore, as used herein, the singular forms of “a”, “an”, and “the” are intended to include the plural forms as well, unless the context clearly indicates otherwise.

What is claimed is:

1. A method for providing enhanced learning content in an interconnected smart environment, the method comprising:
determining, by one or more computer processors, one or more objects and associated object capabilities for each of the one or more objects in the interconnected smart environment;
determining, by the one or more computer processors, one or more user activities and associated user data;
determining, by the one or more computer processors, one or more subject matter scores based, at least in part, on the one or more user activities and the associated user data;
determining, by the one or more computer processors, a level of engagement for a topic based, at least in part, on the one or more subject matter scores and the associated object capabilities for each of the one or more objects in the interconnected smart environment, wherein the level of engagement indicates a volume and a scope of enhanced learning content to be provided to a user;
detecting, by the one or more computer processors, the user performing an activity related to the topic; and
responsive to detecting the user performing the activity related to the topic, providing, by the one or more computer processors, based, at least in part, on the level of engagement, the enhanced learning content to the user utilizing a smart device and the one or more objects in the interconnected smart environment.

2. The method of claim 1, wherein determining the one or more objects and the associated object capabilities for each of the one or more objects, further comprises:
instructing, by one or more computer processors, one or more smart devices in the interconnected smart environment to identify the one or more objects and the associated object capabilities for each of the one or more objects, wherein identifying the one or more objects and associated object capabilities for each of the one or more objects includes querying a knowledge base to derive associated object capabilities for each of the one or more objects.

3. The method of claim 1, wherein determining the one or more user activities and the associated user data, further comprises:
recording, by the one or more computer processors, a point in time for various learning sessions and an area of interest for learning for the user.

4. The method of claim 3, further comprising:
classifying, by the one or more computer processors, each of the one or more user activities and the associated user data by subject matter, by user interest related to the topic, and by a level of understanding of the topic.

5. The method of claim 1, wherein determining the one or more subject matter scores, further comprises:
calculating, by the one or more computer processors, a plurality of weighted values for each of one or more categories; and
assigning, by the one or more computer processors, the one or more subject matter scores to each of the one or more categories, wherein the one or more subject matter scores indicate a level of understanding for the user relative to one or more specific topics and one or more subject matter areas.

6. The method of claim 1, wherein determining the level of engagement for the topic, further comprises:
comparing, by the one or more computer processors, the one or more subject matter scores for the user to the associated object capabilities for each of the one or more objects available; and
determining, by the one or more computer processors, a level of engagement for the topic, where the level of engagement is an indication of a level of involvement from one or more smart devices and the one or more objects, and a volume of the enhanced learning content provided by the one or more smart devices, wherein the volume of the enhanced learning content aligns with an educational requirement of the user.

7. The method of claim 1, further comprising:
detecting, by the one or more computer processors, the user performing the activity related to the topic by leveraging artificial intelligence (AI) and machine learning techniques to identify when the user interacts with the one or more objects and one or more smart devices in the interconnected smart environment.

8. The method of claim 1, further comprising:
creating, by the one or more computer processors, the enhanced learning content relative to the topic, wherein the enhanced learning content includes elements of gamification techniques.

9. The method of claim 1, further comprising:
delivering, by the one or more computer processors, visualizations of the enhanced learning content to the user utilizing an augmented reality system within the interconnected smart environment.

10. A computer program product for providing enhanced learning content in an interconnected smart environment, the computer program product comprising:
one or more computer readable storage media and program instructions stored on the one or more computer readable storage media, the stored program instructions comprising:
program instructions to determine one or more objects and associated object capabilities for each of the one or more objects in the interconnected smart environment;
program instructions to determine one or more user activities and associated user data;
program instructions to determine one or more subject matter scores based, at least in part, on the one or more user activities and the associated user data;
program instructions to determine a level of engagement for a topic based, at least in part, on the one or more subject matter scores and the associated object capabilities for each of the one or more objects in the interconnected smart environment, wherein the level of engagement indicates a volume and a scope of enhanced learning content to be provided to a user;
program instructions to detect the user performing an activity related to the topic; and
program instructions to, responsive to detecting the user performing the activity related to the topic, provide based, at least in part, on the level of engagement, the enhanced learning content to the user utilizing a smart device and the one or more objects in the interconnected smart environment.

11. The computer program product of claim 10, the program instructions to determine the one or more objects and the associated object capabilities for each of the one or more objects, further comprising:
program instructions to instruct one or more smart devices in the interconnected smart environment to identify the one or more objects and the associated object capabilities for each of the one or more objects, wherein identifying the one or more objects and associated object capabilities for each of the one or more objects includes querying a knowledge base to derive associated object capabilities for each of the one or more objects.

12. The computer program product of claim 10, the program instructions to determine the one or more user activities and the associated user data, further comprising:
program instructions to record a point in time for various learning sessions and an area of interest for learning for the user.

13. The computer program product of claim 12, the stored program instructions further comprising:
program instructions to classify each of the one or more user activities and the associated user data by subject matter, by user interest related to the topic, and by a level of understanding of the topic.

14. The computer program product of claim 10, the program instructions to determine the one or more subject matter scores further comprising:
program instructions to calculate a plurality of weighted values for each of one or more categories; and
program instructions to assign the one or more subject matter scores to each of the one or more categories, wherein the one or more subject matter scores indicate a level of understanding for the user relative to one or more specific topics and one or more subject matter areas.

15. The computer program product of claim 10, the program instructions to determine the level of engagement for the topic further comprising:
program instructions to compare the one or more subject matter scores for the user to the associated object capabilities for each of the one or more objects available; and
program instructions to determine a level of engagement for the topic, where the level of engagement is an indication of a level of involvement from one or more smart devices and the one or more objects, and a volume of the enhanced learning content provided by the one or more smart devices, wherein the volume of the enhanced learning content aligns with an educational requirement of the user.

16. The computer program product of claim 10, the stored program instructions further comprising:
program instructions to detect the user performing the activity related to the topic by leveraging artificial intelligence (AI) and machine learning techniques to identify when the user interacts with the one or more objects and one or more smart devices in the interconnected smart environment.

17. The computer program product of claim 10, the stored program instructions further comprising:
program instructions to create the enhanced learning content relative to the topic, wherein the enhanced learning content includes elements of gamification techniques.

18. The computer program product of claim 10, the stored program instructions further comprising:
program instructions to deliver visualizations of the enhanced learning content to the user utilizing an augmented reality system within the interconnected smart environment.

19. A computer system for providing enhanced learning content in an interconnected smart environment, the computer system comprising:
one or more computer processors;
one or more computer readable storage media; and
program instructions stored on at least one of the one or more computer readable storage media for execution by at least one of the one or more computer processors, the stored program instructions comprising:
program instructions to determine one or more objects and associated object capabilities for each of the one or more objects in the interconnected smart environment;
program instructions to determine one or more user activities and associated user data;
program instructions to determine one or more subject matter scores based, at least in part, on the one or more user activities and the associated user data;
program instructions to determine a level of engagement for a topic based, at least in part, on the one or more subject matter scores and the associated object capabilities for each of the one or more objects in the interconnected smart environment, wherein the level of engagement indicates a volume and a scope of enhanced learning content to be provided to a user;
program instructions to detect the user performing an activity related to the topic; and
program instructions to, responsive to detecting the user performing the activity related to the topic, provide based, at least in part, on the level of engagement, the enhanced learning content to the user utilizing a smart device and the one or more objects in the interconnected smart environment.

20. The computer system of claim 19, the program instructions to determine the one or more objects and the associated object capabilities for each of the one or more objects further comprising:
program instructions to instruct one or more smart devices in the interconnected smart environment to identify the one or more objects and the associated object capabilities for each of the one or more objects, wherein identifying the one or more objects and associated object capabilities for each of the one or more objects includes querying a knowledge base to derive associated object capabilities for each of the one or more objects.
